(19) United States
(12) Patent Application Publication
(10) Pub. No.: US 2017/0074341 A1
(43) Pub. Date: Mar. 16, 2017

(54) Air Spring Device for a Vehicle

(71) Applicant: Robert Bosch GmbH, Stuttgart (DE)

(72) Inventors: Stefan Leidich, Rutesheim (DE); Andreas Merz, Freiberg Am Neckar (DE); Remigius Has, Grafenau-Daetzingen (DE)

(21) Appl. No.: 15/258,778

(22) Filed: Sep. 7, 2016

(30) Foreign Application Priority Data
Sep. 10, 2015 (DE) 10 2015 217 254.6

(51) Int. Cl. F16F 9/04; F16F 9/05; F16F 9/32; B60G 11/27

(52) U.S. Cl. CPC F16F 9/0409; B60G 11/27; F16F 9/05; F16F 9/3292; F16F 2230/08; B60G 2400/252; B60G 2401/17; B60G 2206/42

(57) ABSTRACT

An air spring device for a vehicle includes a cover element, base element, spring-elastic sleeve, and distance sensor unit. The sleeve, together with the cover and base elements, defines an internal space, and includes a first section forming a first spring element having a first length and first spring constant and a second section forming a second spring element having a second length and second spring constant. The distance sensor unit is positioned in the internal space, is configured to determine a distance between the cover element and base element, and includes a measured value encoder and measured value pickup. A first of the encoder and pickup is positioned on the cover or base element. A second of the encoder and pickup is coupled to the cover element via the first spring element and to the base element via the second spring element.

This application claims priority under 35 U.S.C. §119 to patent application no. DE 10 2015 217 254.6, filed on Sep. 10, 2015 in Germany, the disclosure of which is incorporated herein by reference in its entirety.

The present disclosure relates to an air spring device for a vehicle having a spring-elastic sleeve which, with a cover element and a base element, encloses an internal space in which a distance sensor unit with a measured value encoder and a measured value pickup is arranged, by means of which distance sensor unit a current distance between the cover element and the base element can be determined.

### BACKGROUND

Modern air springs for trucks are generally equipped with a sensor system for determining the spring compression travel. This information can be used for the chassis control. These air springs comprise a plurality of air spring devices which each comprise a cylindrical sleeve which encloses, with a cover element and a base element, an internal space in which a distance sensor unit determines the distance between the cover element and the base element, on the basis of which distance the spring compression travel can be determined. The lateral face of the cylindrical sleeve is composed of rubber, and the volume of the internal space can be inflated by means of compressed air and correspondingly stiffened and adjusted in terms of height. In the installed state, one of the elements, either the cover element or the base element is fixedly connected to the chassis of the vehicle, while the other element is movably mounted.

The publication DE 10 2006 017 275 A1 discloses an air spring device with an integrated height measuring device which comprises a pressure space or internal space, an analog proximity sensor which is arranged outside the internal space but oriented extending into the internal space and a metal plate which is arranged opposite the proximity sensor in the internal space.

The publication U.S. Pat. No. 5,859,692 A discloses an air spring device for a vehicle having a spring-elastic sleeve which encloses, with a cover element and a base element, an internal space in which a distance sensor unit with a measured value encoder and a measured value pickup is arranged, by means of which distance sensor unit a current distance between the cover element and the base element can be determined. In this context, a first sensor component is arranged on the cover element or on the base element, and a second sensor component is coupled to the cover element via a first spring element, which is embodied as a helical spring and has a first length and a first spring constant, and to the base element via a second spring element, which is embodied as a helical spring and has a second length and a second spring constant.

### SUMMARY

It is therefore the object of the present disclosure to provide an air spring device for a vehicle having the advantage of a cost-effective determination of the distance between a base element and a cover element and therefore of spring compression travel of an air spring device, this being possible without additional spring elements.

The object is achieved by an air spring device for a vehicle having the features of the disclosure. Advantageous developments of the disclosure will be apparent from the claims.

According to the disclosure, an air spring device for a vehicle having a spring-elastic sleeve which, with a cover element and a base element, encloses an internal space in which a distance sensor unit with a measured value encoder and a measured value pickup is arranged, by means of which distance sensor unit a current distance between the cover element and the base element can be determined. A first sensor component, i.e. either the measured value encoder or the measured value pickup, is arranged on the cover element or on the base element, and a second sensor component, i.e. either the measured value pickup or the measured value encoder, is coupled to the cover element via a first spring element, which has a first length and a first spring constant, and to the base element via a second spring element which has a second length and a second spring constant. In this context, a first section of the spring-elastic sleeve forms the first spring element, and a second section of the spring-elastic sleeve forms the second spring element.

An evaluation and control unit can be understood here to be an electric apparatus such as, for example, a control apparatus which processes and/or evaluates detected sensor signals. Alternatively, the evaluation and control unit can also be integrated into the sensor unit. The evaluation and control unit can have at least one interface which can be embodied by means of hardware and/or software. In the case of a hardware embodiment, the interfaces may be, for example, part of what is referred to as a system ASIC which includes a wide variety of functions of the evaluation and control unit. However, it is also possible for the interfaces to be separate, integrated circuits or to be composed at least partially of discrete components. In the case of a software embodiment, the interfaces can be software modules which are present, for example, on a microcontroller in addition to other software modules. A computer program product with program code which is stored on a machine-readable carrier such as a semiconductor memory, a hard disk memory or an optical memory and used to carry out the evaluation when the program is executed by the evaluation and control unit is also advantageous.

A sensor unit is understood here to be a structural unit which comprises at least one sensor element which detects a physical variable or a change in a physical variable directly or indirectly and preferably converts it into an electrical sensor signal. This can be done, for example, by emitting and/or receiving electromagnetic waves and/or by means of a magnetic field or by means of the change in a magnetic field. The at least one sensor element can be embodied, for example, as an eddy current sensor element and/or a Hall sensor element and/or magneto-resistive sensor element and/or inductive sensor element. The change in a magnetic field can be registered, for example, by means of the voltage produced by magnetic induction. The determination of the sensor signals can take place statically and/or dynamically. Furthermore, the determination of the sensor signals can be carried out continuously or once.

It is particularly advantageous that the two sections of the spring-elastic sleeve can generate the different spring constants of the spring elements by means of different rigidities. In order to convert the different spring constants, the first section of the spring-elastic sleeve can have, for example, a thickened portion which reduces a clear diameter of the first section of the spring-elastic sleeve compared to the clear diameter of the second section of the spring-elastic sleeve. In addition, the second sensor component, i.e. either the measured value pickup or the measured value encoder, can be mounted on the thickened portion. In order to permit an exchange of fluid between the upper part of the internal space, enclosed by the first section of the spring-elastic sleeve, and the lower part of the internal space, enclosed by the second section of the spring-elastic sleeve, openings which connect the upper and the lower part of the internal space fluidically to one another can be provided in the thickened portion and/or in the second sensor component.

In one advantageous refinement of the air spring device for a vehicle, the distance sensor unit can detect a physical variable and can output a signal representing the physical variable to an evaluation and control unit which can evaluate the detected physical variable and determine a current distance between the cover element and the base element on the basis of the evaluation. The spring compression travel can be calculated from the current distance between the cover element and the base element.

In a further advantageous refinement of the air spring device for a vehicle, a selected ratio of the spring constants and/or the spring lengths of the two spring elements can reduce a maximum distance between the cover element and the base element in the unloaded state into a measurement travel which can represent a distance between measured value encoder and measured value pickup in the unloaded state. As a result, the measurement travel can advantageously be significantly reduced, with the result that the distance sensor unit can be given smaller dimensions, since the distance between the measured value encoder and the measured value pickup is smaller than the distance between the cover element and the base element by virtue of the reduction ratio.

In a further advantageous refinement of the air spring device for a vehicle, the distance sensor unit can be embodied as an eddy current sensor unit with the measured value encoder which is embodied as a metal plate and a measured value pickup which is embodied as a sensor coil. Alternatively, the distance sensor unit can be embodied as a magnetic sensor unit having a measured value encoder which is embodied as a permanent magnet and a measured value pickup which is embodied as a magnetic field sensor.

By virtue of the embodiment of the measured value encoder as a metal plate or permanent magnet, an active electronic circuit is necessary only at the installation location of the measured value pickup, and therefore a plug or connecting cable is also necessary only at the installation location of the measured value pickup. Since routing cables via movably mounted components is generally problematic, the measured value pickup is arranged on the terminating element of the air spring device which is connected to the chassis in a positionally fixed fashion. This means that the measured value pickup is arranged on the cover element when the cover element of the air spring device is connected to the chassis in a positionally fixed fashion. If the base element of the air spring device is connected to the chassis in a positionally fixed fashion, the measured value pickup is arranged on the base element.

### BRIEF DESCRIPTION OF THE DRAWINGS

Further measures that improve the disclosure are explained in greater detail below with reference to the figures together with the description of preferred illustrative embodiments of the disclosure.

FIG. 1 shows a schematic sectional illustration of an exemplary embodiment of an air spring device according to the disclosure for a vehicle.

FIG. 2 shows a schematic sectional illustration of a further exemplary embodiment of an air spring device according to the disclosure for a vehicle.

### DETAILED DESCRIPTION

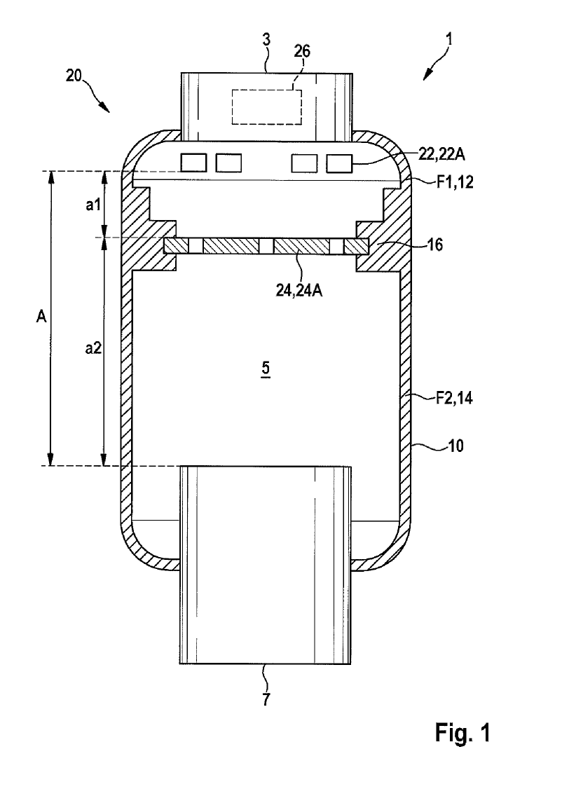

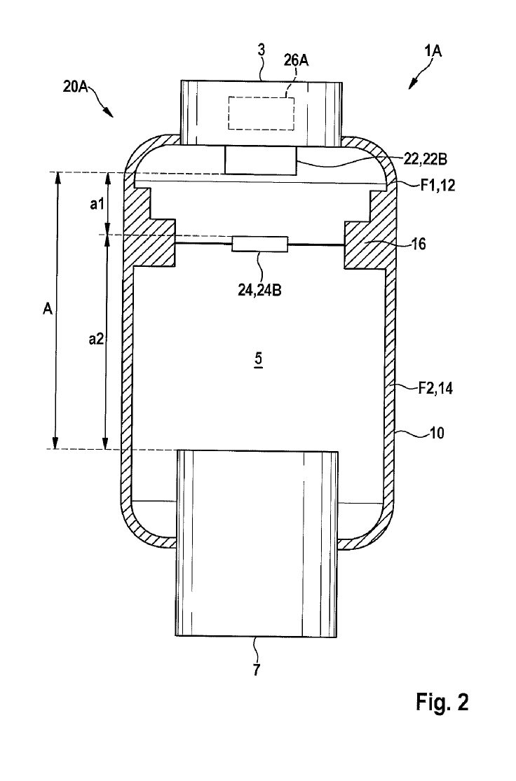

As is apparent from FIGS. 1 and 2, the illustrated exemplary embodiments of an air spring device 1, 1A according to the disclosure for a vehicle each comprise a spring-elastic sleeve 10 which, with a cover element 3 and a base element 7, encloses an internal space 5 in which a distance sensor unit 20, 20A with a measured value encoder 24 and a measured value pickup 22 is arranged. A current distance between the cover element 3 and the base element 7 can be determined by means of the distance sensor unit 20, 20A, wherein a first sensor component, i.e. either the measured value encoder 24 or the measured value pickup 22 is arranged on the cover element 3 or on the base element 7, and a second sensor component, i.e. either the measured value pickup 22 or measured value encoder 24, is coupled to the cover element 3 via a first spring element F1, which has a first length a1 and a first spring constant K1, and to the base element 7 via a second spring element F2, which has a second length a2 and a second spring constant K2. In the illustrated exemplary embodiments, the measured value pickup 22 is arranged in each case on the cover element 3, and the measured value encoder 24 is coupled to the cover element 3 and the base element 7 via the spring elements F1, F2. In this context, a first section 12 of the spring-elastic sleeve 10 forms the first spring element F1, and a second section 14 of the spring-elastic sleeve 10 forms the second spring element F2.

As is also apparent from FIGS. 1 and 2, the two sections 12, 14 of the spring-elastic sleeve 10 generate the different spring constants K1, K2 of the spring elements F1, F2 by means of different rigidities. The spring-elastic sleeve 10 is manufactured, for example, from rubber or from some other suitable elastic material. In order to form different rigidities, the spring-elastic sleeve 10 has, in the first section 12, a thickened portion 16 which increases the rigidity of the first section 12 compared to the rigidity of the second section 14. The first spring element F1 therefore also has a higher first spring constant K1 than the first spring element F2, which has a smaller spring constant K2.

As is also apparent from FIGS. 1 and 2, the measured value encoder 24 is mounted in each case on the thickened portion 16. In addition, a perforation is provided on the measured value encoder 24 in order to permit an exchange of fluid between the upper part of the internal space 5, enclosed by the first section 12 of the spring-elastic sleeve 10, and the lower part of the internal space 5, enclosed by the second section 14 of the spring-elastic sleeve 10.

In the illustrated exemplary embodiments, the respective distance sensor unit 20, 20A detects a physical variable and outputs a signal representing the physical variable to an evaluation and control unit 26. The evaluation and control unit 26 is arranged in the cover element 3 in the illustrated exemplary embodiments and evaluates the detected physical variable. On the basis of the evaluation, the evaluation and control unit 26 determines a current distance between the cover element 3 and the base element 7. A maximum distance A between the cover element 3 and the base element 7 in the unloaded state of the air spring device 1, 1A is translated into a maximum measurement travel by means of a selected ratio of the spring constants K1, K2 and/or the two spring lengths a1, a2 of the two spring elements F1, F2, which maximum measurement travel represents a distance between the measured value encoder 22 and the measured value pickup 24 in the unloaded state of the air spring device 1, 1A.

In the illustrated exemplary embodiments, the dimensioning of the spring rigidities K1, K2 and spring lengths a1, a2 is subject to the following peripheral conditions: the length A of the spring system corresponds to a sum of the first spring length a1 and of the second spring length a2. In the unloaded state of the air spring device 1, 1A, a maximum length Amax can be, for example, 100 mm. In the loaded state or spring-compression state of the air spring device 1, 1A a minimum length Amin can be, for example, 20 mm. The first spring length a1 of the first spring element F1 should be a maximum first spring length a1max of, for example, 5 mm in the unloaded state. In the spring-compression state, a minimum first spring length a1min should be, for example, approximately 2 mm. In this range from 2 to 5 mm distance, a corresponding distance sensor unit 20, 20A between the measured value encoder 24 and the measured value pickup 22 is particularly sensitive. Therefore, exemplary embodiments of the air spring device 1, 1A reduce the maximum travel between the maximum length Amax and the minimum length Amin from 80 mm to a measurement travel between the maximum first spring length a1max and the minimum first spring length a1min of 3 mm. Amax-a1max results in a value of 95 mm for the maximum second spring length a2max of the second spring element F2, and Amin-a1min results in a value of 18 mm for the minimum second spring length a2min of the second spring element F2. The added rigidities Kg of the first spring rigidity K1 and the second spring rigidity K2 should not contribute significantly to the overall spring effect. Therefore, for a predefined total force Fg the first spring constant K1 for the first spring element F1 is produced according to Equation (1), and the second spring constant K2 for the second spring element F2 is produced in accordance with Equation (2).

K1=Fg/(a1ₘₐₓ−a1ₘᵢₙ)=Fg/(5 mm−2 mm)=333.33[1/m]*Fg (1)

K2=Fg/(a2ₘₐₓ−a2ₘᵢₙ)=Fg/(95 mm−18 mm)=12.99[1/m]*Fg (2)

The total rigidity Kg is obtained according to Equation (3).

Kg=1/((1/K1)+(1/K2)) (3)

The total force Fg should be less than 50 N. This results in a value of approximately 16 666 [N/m] for the first spring constant K1, and a value of approximately 649 [N/m] for the second spring constant K2, and a value of approximately 625 [N/m] for the spring constant Kg of the entire system. In the spring-compression state of the air spring device 1, 1A, the reaction force is 50 N. The first spring element F1 is compressed from the maximum first length a1max of 5 mm by 50 [N]/16 666 [N/m]=3 mm. The resulting minimum first length a1min is 2 mm. In this way, the large travel of Amax=100 mm is reduced to Amin=20 mm over a significantly smaller region.

As is also apparent from FIG. 1, the distance sensor unit 20 in the illustrated first exemplary embodiment is embodied as an eddy current sensor unit with a measured value encoder 24 which is embodied as a metal plate 24A, and a measured value pickup 22 which is embodied as a sensor coil 22A. The eddy current sensor unit is composed of the sensor coil 22A and the metal plate 24A. The sensor coil 22A is preferably operated in an oscillatory circuit (not illustrated in more detail) or has an alternating current with a predefined frequency applied to it in some other way. The frequency is, for example, in the range from 0.1-100 MHz. The applied alternating current induces a voltage in the metal plate, which gives rise to a flow of current. The flow of current influences the propagation of the magnetic field of the sensor coil 22A. Ultimately, the inductance of the sensor coil 22A is therefore reduced. The effect can be measured using suitable techniques by means of the evaluation and control unit 26 coupled electrically to the sensor coil 22A. It is therefore possible, for example, to determine the frequency of the exciting oscillatory circuit. The effect is heavily dependent on the distance a1 between the sensor coil 22A and the metal plate 24A. It is known from practice that the maximum permissible distance a1max should only be approximately 50% of the coil diameter. In the case of the suspension of a truck this restriction is disadvantageous since the spring elements tend to be embodied with a length which is greater than their width. However, as a result of the reduced measuring range a significantly smaller diameter is necessary for the sensor coil 24A, with the result that there is no restriction of the use of the air spring device 1. In the abovementioned specific numerical example, a coil with a diameter of 12.5 mm is sufficient.

As is also apparent from FIG. 2, the distance sensor unit 20A in the illustrated second exemplary embodiment is embodied as a magnetic sensor unit with a measured value encoder 22 which is embodied as a permanent magnet 22B, and a measured value pickup 24 which is embodied as a magnetic field sensor 24B. The magnetic field sensor 24B can be embodied, for example, as a Hall sensor or GMR sensor or TMR sensor. The reduction of the large travel is also advantageous in this case. Alternatively, the permanent magnet 24B would have to be made very large.

Embodiments of the air spring device according to the disclosure can preferably be used in modern air spring systems for motor vehicles, in particular for trucks.

What is claimed is:

1. An air spring device for a vehicle comprising:
a cover element;
a base element;
a spring-elastic sleeve that, together with the cover element and the base element, defines an internal space, and that includes:
a first section that forms a first spring element having a first length and a first spring constant; and
a second section that forms a second spring element having a second length and a second spring constant; and
a distance sensor unit that is positioned in the internal space, that is configured to determine a distance between the cover element and the base element, and that includes:
a measured value encoder; and
a measured value pickup;
wherein:
a first of the measured value encoder, and the measured value pickup is positioned on the cover element or on the base element; and
a second of the measured value encoder and the measured value pickup is coupled to the cover element via the first spring element and to the base element via the second spring element.

2. The air spring device according to claim 1, wherein:
the first section and the second section have respective rigidities that are different from each other;
the first spring constant and the second spring constant are defined by the respective rigidities.

3. The air spring device according to claim 2, wherein the first section has a thickened portion relative to the second section.

4. The air spring device according to claim 3, wherein the second sensor component is mounted on the thickened portion.

5. The air spring device according claim 1, further comprising an evaluation and control unit, wherein:
the distance sensor unit is configured to detect a physical variable and output a signal representing the physical variable to the evaluation and control unit; and
the evaluation and control unit is configured to evaluate the physical variable and determine the distance between the cover element and the base element.

6. The air spring device according to claim 1, wherein:
a ratio of at least one of (i) the first spring constant and the second spring constant and (ii) the first spring length and the second spring length enables translation of a maximum distance between the cover element and the base element in an unloaded state into a measurement travel, the measurement travel representing a first distance between the measured value encoder and the measured value pickup in the unloaded state.

7. The air spring device according claim 1, wherein the distance sensor unit is embodied as an eddy current sensor unit that includes:
a metal plate that forms the measured value encoder; and
a sensor coil that forms the measured value pickup.

8. The air spring device according to claim 1, wherein the distance sensor unit is embodied as a magnetic sensor unit that includes:
a permanent magnet that forms the measured value encoder; and
a magnetic field sensor the measured value pickup.
